(19) United States
(12) Patent Application Publication
(10) Pub. No.: US 2008/0050548 A1
(43) Pub. Date: Feb. 28, 2008

(54) DECORATIVE ARTICLE WITH CONTROL SHRINKAGE CARRIER

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/852,134

(22) Filed: Sep. 7, 2007

Related U.S. Application Data
(63) Continuation-in-part of application No. 11/460,493, filed on Jul. 27, 2006.
(60) Provisional application No. 60/825,073, filed on Sep. 8, 2006.
(60) Provisional application No. 60/703,925, filed on Jul. 28, 2005.
(60) Provisional application No. 60/704,681, filed on Aug. 1, 2005.
(60) Provisional application No. 60/707,577, filed on Aug. 11, 2005.
(60) Provisional application No. 60/710,368, filed on Aug. 22, 2005.
(60) Provisional application No. 60/716,869, filed on Sep. 13, 2005.
(60) Provisional application No. 60/719,469, filed on Sep. 21, 2005.
(60) Provisional application No. 60/779,317, filed on Mar. 3, 2006.
(60) Provisional application No. 60/786,528, filed on Mar. 27, 2006.

(51) Int. Cl. B32B 7/12; B05D 1/16

(52) U.S. Cl. 428/41.8; 427/462

(57) ABSTRACT

The present invention is directed to flocked articles comprising a control shrinkage carrier film to absorb thermally induced shrinkage of other layers in the flocked article.

### CROSS REFERENCE TO RELATED APPLICATION

The present application (a) claims the benefits, under 35 U.S.C.§119(e), of U.S. Provisional Application Ser. No. 60/825,073, filed Sep. 8, 2006, entitled Decorative Article with Control Shrinkage Carrier” and (b) is a continuation-in-part of U.S. patent application Ser. No. 11/460,493, filed Jul. 27, 2006, entitled “Flocked Articles Incorporating a Porous Film”, which claims the benefits, under 35 U.S.C.§119(e), of U.S. Provisional Application Ser. Nos. 60/703,925, filed Jul. 28, 2005, entitled “Flocked Design with Three Dimensional Metallic Insert”; 60/704,681, filed Aug. 1, 2005, of the same title; 60/707,577, filed Aug. 11, 2005, of the same title; 60/710,368, filed Aug. 22, 2005, of the same title; 60/716,869, filed Sep. 13, 2005, of the same title; 60/719,469, filed Sep. 21, 2005, of the same title; 60/779,317, filed Mar. 3, 2006, of the same title; and 60/786,528, filed Mar. 27, 2006, of the same title; each of which is incorporated herein by this reference.

### FIELD

The invention relates generally to flocked articles and particularly to flocked graphics.

### BACKGROUND

Flocked articles are used in a wide variety of applications. Flocked articles are being used for textile decoration as well as molded articles. Flock is a short precision cut or pulverized natural or synthetic fiber used to produce a velvet like coating on cloth, rubber, film, or paper. Flock generally has a length between about 0.010 to 0.250 inches (0.25 mm to 6.25 mm).

There are two methods employed to produce flocked articles. In one method known as direct flocking, flock fibers are electrostatically deposited on an adhesive coated substrate. The substrate is typically a textile but can be any type of material, such as rubber, polycarbonate, and the like. The other method is known as a flocked transfer. In a flocked transfer, the flock fibers are first electrostatically deposited on a temporary or release adhesive coated sacrificial carrier, such as paper or a polymeric (polyester) film. A permanent adhesive is applied to the free surface of the flock fibers. The resulting article is known as a transfer. To apply the flock fibers to a desired substrate, such as a textile, the permanent adhesive is contacted with the substrate and heat applied to bond the adhesive to the substrate. The carrier and attached release adhesive are then removed to reveal a free flock surface.

In forming flocked articles, there a number of considerations. First, the substrate or carrier as the case should be conductive and minimally impact the orientation of the electric field lines. When the electric field lines are altered by an electrically insulating substrate, the flock fibers are not orthogonal to the plane of the substrate or carrier and therefore misoriented. Not only the touch and plushness but also the longevity of the article can be adversely impacted by such fiber misorientations. Second, the release adhesive should more strongly adhere to the carrier than the fibers to prevent substantial amounts of release adhesive from remaining on the fibers after removal of the carrier. Such residual adhesive would need to be removed to provide a desired touch to the exposed flock surface, thereby increasing manufacturing costs. To address this issue, manufacturers generally use multiple layers of release adhesive, which can be expensive to apply. The carrier should be earth friendly as carrier will be discarded after use. However, most carriers use a petroleum-based finish, which not only increases carrier cost but also is harmful to the environment when discarded. Finally, the carrier should be water resistant to permit the use of water-based adhesives. Such adhesives are generally far less toxic, and safer to use, than solvent-based adhesives. The problem is that manufacturers have been unable to find a carrier that is both inexpensive and water-resistant. The paper carrier that is most frequently used is not water-resistant, thereby requiring the use of solvent-based adhesives.

Other considerations can arise for specific flocked article designs. With reference to FIG. 15, a flock transfer 1500 includes a carrier 1504 that shrinks or softens under certain conditions. In one design, a rigid polyester film, such as polyethylene terephthalate (PET), is used as the carrier 1504. A release adhesive layer 1200 adheres flock fibers to the carrier film 1504. A flock adhesive layer 1508, such as a latex adhesive, is applied, in liquid form, to the upper surface 1512 of the flock 1104. A permanent adhesive layer 1516, such as a powdered hot-melt adhesive, is applied to the free surface of the permanent adhesive layer 1508. During manufacture, the liquid flock adhesive in the flock transfer 1500 is dried at room or elevated temperature, which causes the flock adhesive and permanent adhesive layers 1508, 1516 to shrink due to loss of mass (liquid), as shown by the inwardly facing arrows in each layer. Further shrinkage and/or deformation can result during baking, curing, and/or application to a desired substrate and subsequent cooling. When a rigid or semi-rigid carrier film, such as PET, is used, the inability of the carrier film 1504 (as shown by the much smaller inwardly facing arrows) to absorb the shrinkage tension causes the design to curl when the carrier film 1504 is removed. Such curling is shown in FIG. 17. FIG. 17 shows a number “1” after removal from the release adhesive and carrier sheet 1200, 1504. When the transfer is removed, it is free to shrink to a smaller size and does so due to a difference in tension (or size) between the shrunken flock and/or hot-melt adhesives 1508, 1516. A curled design is unable to be positioned accurately on a desired substrate when applied thereto. The design, for optimal appearance, must lie substantially flat on the substrate to be positioned accurately.

### SUMMARY

These and other needs are addressed by the various embodiments and configurations of the present invention. The present invention is directed to flocked articles and graphics comprising a porous film.

In one embodiment of the present invention, a flocked article or graphic includes a porous film, which is preferably a film having micro- and/or macroporosity. The film can be any film or substrate that is porous and is preferably gas (air) permeable. More preferably, the porous film includes one or more organic polymers and a metal oxide particulate filler. An exemplary filler is ordinary sand. In various flocked articles and graphics, the film can be used as a sacrificial carrier, a flocked substrate, a binder for otherwise incompatible or weakly compatible materials, or as an intermediate layer to provide desired properties to the article or graphic.

The preferred film can have a number of highly beneficial properties including:

(i) high mechanical adhesion potential for both water-based adhesives, such as acrylic (latex) adhesives coatings, solvent-based adhesives, and pre-formed, self-supporting thermoset and thermoplastic heat-activated adhesives;

(ii) high water resistance so that the film is relatively unaffected by water in the water-based adhesives;

(iii) a high enough tensile strength to serve as a tie-coat to hold together two different materials on either side while adding a high degree of opacity to the laminate;

(iv) semiconductive or highly conductive properties so that at least most of the electrostatic field normally used in flocking passes through the substrate in a direction substantially perpendicular to the substrate surface, leading to superior flock orientation and density on the substrate surface;

(v) high degree of heat resistance to enable the material to withstand processing with heat without loss of integrity and with a shrinkage of no more than about 3%;

(vi) largely composed of environmentally compatible components (e.g., sand); and/or

(vii) the ability to be bonded by high frequency energy to a second piece of the film and/or other compatible material.

The high degree of adhesion of the film to release and permanent adhesives is believed to be due to the effect of porosity. While not wishing to be bound by any theory, the roughness created by the porous surface provides substantially increased adhesion.

The water resistance of the film results from the porous film being synthetic and filled substantially with a metal oxide, such as silica power (e.g., sand). The film can be coated with the water-based adhesive and will not wrinkle or shrink but will dry quickly like paper with strong mechanical adhesion. The water resistance can obviate the need to use solvent-based chemical adhesives (and their concomitant toxicity) and the high potential for mechanical adhesion obviates the need to apply special coatings to enable chemical adhesion to conventional synthetic film substrates.

While not wishing to be bound by any theory, the semiconductivity or conductivity is believed to be attributed, at least in part, to the film's air permeability and/or porosity. As well be appreciated, the conductivity of a film is directly related to its air permeability and/or porosity. The relatively high strength of the electrostatic field on the flocking side of the film commonly causes at least about 80%, more commonly at least about 90%, even more commonly at least about 95%, and even more commonly at least about 98% of the flock fibers on the film after flocking to be embedded in the release adhesive/permanent adhesive on the film and the same percentages of flock fibers to have the desired orientation of being substantially perpendicular to the plane of the film and adhesive surfaces. The density of the flock on the surfaces is also typically higher than the density of flock using other common carriers, such as plastic films.

The porous film can bond well to a number of otherwise compatible and noncompatible materials on opposite sides, thus serving well as a so-called “tie coat” layer. For example, the film bonds to a variety of adhesives as noted above. The adhesives can be applied as a thermoplastic powder, a self-supporting heat-activated film, or as a liquid coating. In particular, the film may be readily laminated to preformed, self-supporting films of thermoset and/or thermoplastic adhesive(s), including hot melt adhesive(s). In addition, the present invention has found that the porous film can be bonded by high frequency energy to a second piece of porous film and/or other compatible material. In this way, as will be described more fully herein, a plurality of products made using the porous film can be bonded to a continuous sheet of porous film in succession to form a sheet of porous film having a plurality of transfers bonded thereto.

Flock adhesion, orientation, and density is similar and, in some cases, superior to that realized using cellulose substrates (e.g., paper) and non-water-based adhesives. Unlike paper, the porous film can accept water-based release adhesives with high mechanical adhesion (which thereby provides a much higher adhesive force of the release adhesive to the film so when peel force is applied the adhesive will “prefer” to adhere to the porous film than to embedded flock fibers which, if synthetic, usually have very smooth side surfaces so they may be pulled free and cleanly from release adhesive). Because the film is porous, conductive, and air permeable, the electrostatic high voltage is believed to pass through the film, thereby making anti-static coating unnecessary (for dissipation or discharge of high voltage so charge does not accumulate or build up in the film and thereby reduce the counter potential strength of the electrostatic field). Thus, the electrostatic field will be much stronger than with the film “interfering” with the field lines because the need to maintain the high counter-potential is substantially eliminated and have relatively straight lines of force in the field. The high voltage charge is able to go straight to the ground, normally a metal palette just below the film sheet, because it can travel straight through the film instead of needing to go around it.

The porous film, though having modest tensile strength when taken alone, can experience substantial improvements in tensile strength when combined with one or more other materials. For example, the film, by itself, lacks the strength of conventional paper carriers and therefore would at first blush appear to be a poor candidate for use in a machine (web) based-process and in products that need to be durable. However, when coated with water or solvent-based release adhesives the release adhesives not only provide an adhesive surface to capture and hold flock fibers but also provides a substantial improvement in film strength after the adhesive is dried and cured. While still wet and with water moving down into the microporous film, this also helps to assist the high voltage go move down through the film due to the high electrical conductivity of water. While not wishing to be bound by any theory, it is believed that the release adhesive is carried into the film matrix by the combined effects of the film's porosity and permeability and, after drying, substantially fills the pores in the film to provide the desired strength enhancement. The synergistic effect of the release adhesive and the porosity/permeability of the film makes the porous film strong enough to withstand the forces applied during subsequent processing stages, such as web-type tensile forces, vacuum cleaning, mechanical brushing, baking, and heat transfer application processes (e.g., heat pressing, cooling, pulling the carrier, and releasing the fibers). Additional support film(s) may nonetheless be added to the side of the porous film opposite the side containing the flock to provide further support.

The porous film can be used not only as a sacrificial carrier in continuous and discontinuous flocking processes but also as a substrate in a flocked design, such as in a sticker, patch, plastic film, etc. Other working parts of the media can be attached to the opposite side of the porous film from the flock fibers. The porous film can be used in both flock transfer carrier media and flock heat transfers. In one media configuration, a sticker is provided that can be readily peeled from a paper backing and adhered to a desired surface. The high degree of pliability of the porous film can make it readily adaptable to this application and suitable for electrostatic flocking. The porous film may be used in both transfer and directing flocking processes and in three dimensional inserts, such as used in molding plastic decorative articles. In mold articles are further discussed in U.S. Pat. No. 6,929,771 and copending U.S. patent application Ser. No. 10/394,357, filed Mar. 21, 2003, each of which is incorporated herein by this reference.

The porous film can be used with multi-colored flocking (in which the flock is dyed before flocking occurs) and single-colored flocking followed by sublimation printing. The temperature resistance of the film in particular makes it amenable to sublimation printing using sublimation dye heat transfer inks by both ink jet printing and sublimation dye transfer techniques. These techniques are further discussed in copending U.S. application Ser. No. 10/614,340, filed Jul. 3, 2003, Ser. No. 11/139,439, filed May 26, 2005, and Ser. No. 11/036,887, filed Jan. 14, 2005, each of which is incorporated herein by this reference.

In yet another embodiment, a control shrinkage carrier film is provided that is able to absorb substantially the shrinkage in layers of a flock transfer. The control shrinkage carrier film has one or more of the following features:

(a) a thermal expansion coefficient that ranges from about 75% to about 125% of a thermal expansion coefficient of the permanent adhesive;

(b) a softening temperature less than an elevated processing temperature to which the transfer is subjected;

(c) a primary component that is the same as a primary component of the permanent adhesive;

(d) a porous and/or cellular structure; and

(e) flexibility.

Although the control shrinkage carrier film can be any polymeric film, it is preferably a porous and/or cellular film, particularly a flexible and/or soft porous and/or cellular film. Microporous films are exemplary of porous films. Foams are exemplary of cellular films. As will be appreciated, foam is a dispersion of a gas in a liquid or solid. When foamed carrier films are used, the foamed material includes stabilizing agents to assure permanence. The pores or cells deform to absorb thermally induced shrinkage in the adhesive layer.

When used as a sacrificial carrier, the porous film can be much superior to other carriers such as paper because the porous film is compatible with water-based adhesives. With paper, there is a high risk of water in water-based adhesives attacking the cellulose fibers making them swell and the paper wrinkle and shrink in the presence of water. As a result of this problem, solvent-based adhesives have been used with paper carriers. Solvent-based adhesive chemistry requires the use of noxious chemistry in the workplace. Such chemistry produces vapors that are not only potential harmful to personnel but also explosive in the presence of high voltage electrostatic fields, which can emit sparks from time-to-time. Plastisol chemistry is acceptable on paper but requires high temperatures to go through the gel and fusing stages to achieve the full cure. Afterwards, if the adhesive is subjected to relatively high heat, it again runs the risk of becoming tacky from heat, which can mat down the flock fiber coating into the sticky plastisol. Plastisol and some solvent-based adhesives are not electrically conductive or nearly as conductive as water-based adhesives. Finally, water-based adhesives clean up more easily and conveniently than other chemistries and are considered to be generally less harmful to the environment and thus more desirable to use.

Additional benefits of the porous film include low cost, acceptable levels of heat resistance and dimensional stability, and, when composed primarily of the metal oxide filler, is attractive due to its low consumption of petroleum products in its manufacture.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIG. 1 is a side view of a decorative media manufactured using the porous film according to an embodiment of the present invention;

FIG. 2 is a side view of a decorative media manufactured using the porous film according to an embodiment of the present invention;

FIG. 3 is a side view of a flocked article having a noncompatible insert;

FIG. 4 is a side view showing the electric field passing through the porous film;

FIG. 5 is a flow chart depicting the steps to manufacture the direct flocked article of FIG. 1;

FIG. 6 is a flow chart depicting the steps to manufacture the heat transfer of FIG. 2;

FIG. 7 is a flow chart depicting the steps to manufacture a plurality of heat transfers of the type illustrated in FIG. 2;

FIG. 8 is a flow chart depicting an assembly line for manufacturing a plurality of heat transfers of the type illustrated in FIG. 2;

FIG. 9 is a flow chart depicting the steps to manufacture a continuous web of porous having a plurality of transfers bonded thereto;

FIG. 10 is a flow chart depicting an assembly line for manufacturing a continuous web of porous having a plurality of transfers bonded thereto;

FIG. 11 is a plan view of a heat transfer bonded to a continuous web of porous film in accordance with one embodiment of the present invention;

FIG. 12 is a side view of a decorative media according to an embodiment of the present invention;

FIG. 13 is a side view of a decorative heat transfer according to an embodiment of the present invention;

FIG. 14 is a plan view of the heat transfer of FIG. 13;

FIG. 15 is a side view of a prior art heat transfer according to the prior art;

FIG. 16 is a side view of a heat transfer according to an embodiment of the present invention;

FIG. 17 depicts curling of a prior art heat transfer;

FIG. 18 shows a shrinkage control carrier sheet according to the present invention; and

FIG. 19 is a side-by-side comparison of the heat transfer of FIG. 16 against the heat transfer of the present invention.

### DETAILED DESCRIPTION

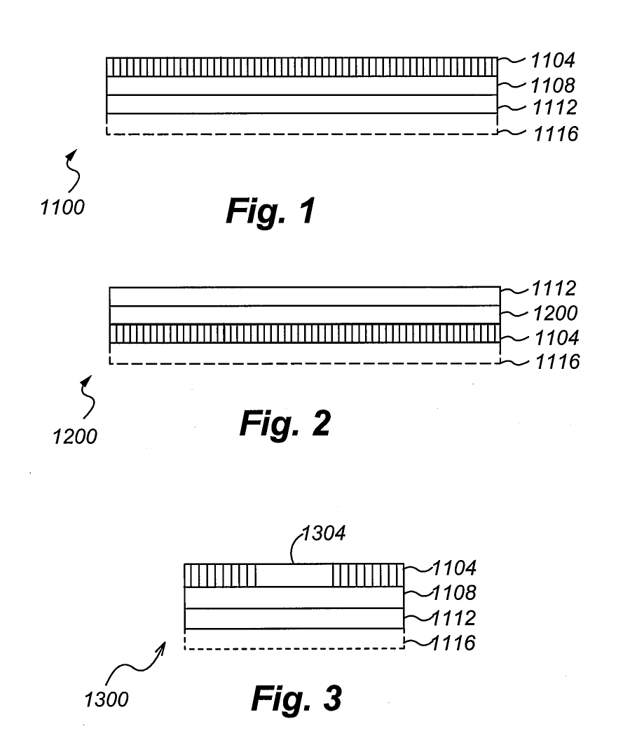

Referring to FIGS. 1-3, decorative media according to embodiments of the present invention are depicted. The media 1100, 1200, and 1300 each comprises a flock layer 1104 and porous film 1112. Media 1100 further includes a first permanent adhesive 1108 and optional second permanent adhesive 1116 on either side of the porous film 1112. Media 1200 further includes a release adhesive 1200 and optional permanent adhesive layer 1116.

The porous film 1112 is preferably a non-woven, microporous material having a small pore size and a controlled caliber. The non-woven film can be calendared to provide a smooth surface suitable for certain types of flocking and printing. The film 1112 preferably includes a matrix of substantially water insoluble, thermoplastic organic polymer, finely divided substantially water-insoluble filler particles, and a network of interconnected pores communicating substantially throughout the microporous material.

The filler particles are preferably porous, inorganic fillers distributed throughout the matrix and constitute from about 40 to about 90 percent by weight of the microporous material. Examples of filler particles include precipitated silica or diatomaceous earth to impart desired characteristics, such as increased micro porosity, increased thermal stability, resistance to flow at elevated temperatures, reduced dielectric strength (as compared to unfilled films), improved ink receptivity, and the like. In one configuration, the filler particles are a metal oxide, such as alumina, silica, and titania with silica being preferred. Preferably, at least 50 percent by weight of the particles are amorphous precipitated silica particles. The particles have a preferred maximum dimension of less than about 5 micrometers, more preferably no more than about 1 micrometer, even more preferably no more than about 0.1 micrometers, and even more preferably no more than about 0.05 micrometers and a preferred average pore size of less than 1 micrometer and more preferably of no more than about 0.1 micrometer. The pores preferably constitute from about 35 to about 95 percent by volume of the microporous material.

The matrix of the microporous material includes a preferably ultra high molecular weight, water-insoluble, thermoplastic organic polymer. Examples of suitable polymers include polyolefins, poly(halo-substituted olefins), polyesters, polyethylenes, polyamides, polyurethanes, polyureas, poly(vinyl halides), poly(vinylidene halides), polystyrenes, poly(vinyl esters), polycarbonates, polyethers, polysulfides, polyimides, polysilanes, polysiloxanes, polycaprolactones, polyacrylates, and polymethylacrylates, with poly(vinyl chloride), copolymers of vinyl chloride, and mixtures thereof being preferred. In one configuration, the matrix material is an ultra high molecular weight polyethylene, used alone or in blends with lower molecular weight polyethylenes or polyolefin copolymers. Alternate systems based on polyesters, polyamides, and halogenated polymers are used in other configurations. The matrix material may further include plasticizers, lubricants, and antioxidants.

The microporous material is preferably coated with a substantially nonporous coating composition including a volatile liquid medium (e.g., water and/or a nonaqueous solvent) and binder dissolved or dispersed in the medium. The coating can be of the type that is dried using, for example, forced air drying ovens, ultraviolet light, electron beam exposure, or the like. The binder includes a film-forming organic polymer, preferably including (a) water-soluble poly(ethylene oxide) having a preferred weight average molecular weight in the range of from about 100,000 to 3,000,000 and (b) water-soluble or water-dispersible crosslinkable urethane-acrylate hybrid polymer. In addition to or in lieu of poly (ethylene oxide), the organic polymer may further include additional organic polymers such as water-soluble cellulosic organic polymers, water-soluble noncellulosic organic polymers, and/or water dispersible polymers such as poly(ethylene-co-acrylic acid), poly(ethylene),and poly(ethylene oxide). In one configuration, the coating includes acrylic polymers, styrene-acrylic polymers, aliphatic polyurethanes, (having either polyether or polyester backbone), polyester resins, and fluoropolymers. In one configuration, the poly(ethylene oxide) includes copolymers of ethylene oxide with lower alkylene oxide and homopolymers of ethylene oxide. Preferably, the organic polymer component of the coating includes from about 20 to about 80% by weight of the urethane-acrylate hybrid polymer. The coating may further include surfactants and adjuvant materials. After drying and crosslinking, the peel strength between the coating and microporous material substrate is high.

The coating can be modified to provide a good resistance to yellowing on exposure to ultraviolet light. Resistance to ultraviolet light degradation can be increased by adding known UV light stabilizer compounds to the formulation. Examples of such stabilizers include hindered amine light stabilizers, benzotriazols, phosphites, antioxidants, and other additives known to those skilled in the art.

The film has a preferred puncture strength of greater than about 300 g/25.4 μm, a preferred tensile strength of less than about 2% at 1000 psi, and a preferred thermal ability of less than about 5% shrinkage after 160 minutes at 90° C.

A preferred porous film is further discussed in U.S. Pat. No. 6,025,068, which is incorporated herein by this reference. A particularly preferred porous film is sold by PPG Industries Inc. under the tradename Teslin™ (a microporous, highly filled polyethylene matrix sheet material). Battery separator membranes can also be used. Examples include Daramic Industrial CL™ (a microporous, highly filled polyethylene matrix sheet material) sold by Daramic, Inc., Solufill™ and Solupor™, both sold by DSM Solutech of the Netherlands and Teijin Fibers Limited of Japan, Tyvek™ (spun bonded polyethylene fibers) sold by E.I. du Pont de Nemours and Company, and the battery separator membranes sold by Celgard, or by Daramic, Inc. under the tradename Artisyn™. Artisyn™ is an uncoated, mono-layer, highly filled polyolefin sheet.

The flock fibers in the flock layer 1104 can be any desirable material, whether natural or synthetic. Preferably, the flock is composed of polyester (such as poly(ethylene terephthalate) and poly(cyclohexylene-dimethylene terephthalate)), vinyl, nylon, rayon, and the like.

The various permanent adhesives 1108 and 1116 can be any suitable adhesive, with water- and solvent-based adhesives and preformed film adhesives being preferred. Preferred permanent adhesives include thermoset and hot melt thermoplastic adhesives, whether as a liquid, powder, or (pre-formed) self-supporting film. As will be appreciated, thermoset adhesives solidify, activate and/or set irreversibly when heated above a certain temperature. This property is usually associated with a cross-linking reaction of the molecular constituents induced by heat or radiation. Thermoset adhesives can include curing agents such as organic peroxides, isocyanates, or sulfur. Examples of thermoplastic and thermosetting adhesives include polyethylene, phenolics, alkyds, acrylics, amino resins, polyesters, epoxides, polyurethanes, polyamides, and silicones.

The release adhesive 1200 can be any temporary adhesive, such as a resin or a copolymer, e.g., a polyvinyl acetate, polyvinyl alcohol, polyvinyl chloride, polyvinyl butyral, acrylic resin, polyurethane, polyester, polyamides, cellulose derivatives, rubber derivatives, starch, casein, dextrin, gum arabic, carboxymethyl cellulose, rosin, silicone, or compositions containing two or more of these ingredients.

The adhesives 1108, 1116, and 1200 may contain additives, such as fillers, catalysts, colorants (dyes or pigments) and optical blocking/reflective/absorbtive materials. The preferred porous film, namely Teslin™ and Artisyn™, can be highly sensitive to Ultraviolet (UV) radiation and can degrade rapidly when exposed to direct sunlight. Accordingly, the adhesives may contain light blocking, absorbing, and/or reflecting materials to decrease substantially the optical transmissivity of the adhesive. Preferably, the adhesive, when on the light contacting side of the porous film, blocks at least about 75%, more preferably at least about 85%, and even more preferably at least about 95% of the UV radiation spectrum. Such optical blocking/reflecting/absorbing materials are known to those of skill in the art.

In a first product configuration, the product is a patch. Referring to FIG. 1, the patch includes the flock layer 1104, first permanent adhesive layer 1108, and porous film 1112. Typically, the patch is free of the second permanent adhesive 1116.

In a second product configuration, the product is a sticker and comprises the flock layer 1104, first permanent adhesive layer 1108, porous film 1112, and second permanent adhesive layer 1116. The second permanent adhesive layer 1116 adheres to a desired substrate, such as a textile.

The first and second product configurations are generally flocked using direct flocking techniques.

In a third product configuration, the product is a heat transfer. Referring to FIG. 2, the heat transfer comprises the porous film 1112 (acting as a carrier), release adhesive layer 1200, the flock layer 1104, and the permanent adhesive layer 1116. As will be appreciated, the release adhesive 1200 and porous film carrier 1108 are removed after the product is applied using heat transfer techniques to a desired substrate, such as a textile. This product is further described in U.S. Pat. Nos. 4,810,549; 5,047,103; 5,207,851; 5,346,746; 5,597,637; 5,858,156; 6,010,764; 6,083,332; and 6,110,560; and copending U.S. applications Ser. No. 10/265,206, filed Oct. 4, 2002; U.S. Ser. No. 10613,981, filed Jul. 3, 2003; Ser. No. 10/613,982, filed Jul. 3, 2003; Ser. No. 10/614,399, filed Jul. 3, 2003; Ser. No. 10/961,821, filed Oct. 7, 2004; Ser. No. 09/621,830, filed Jul. 24, 2000; Ser. No. 09/735,721, filed Dec. 13, 2000; Ser. No. 10/455,575, filed Jun. 4, 2003; Ser. No. 10/670,091, filed Sep. 23, 2003; Ser. No. 10/455,541, filed Jun. 4, 2003; and Ser. No. 11/000,672, filed Nov. 30, 2004, each of which is incorporated herein by this reference.

In a fourth product configuration, the product includes a noncompatible insert 1304. The noncompatible insert 1304 can be any type of media other than flock, such as a reflective material, a hologram, glitter, textiles, metal or metallized films, nonmetal films, glass particles (e.g., sequins), and the like. The product includes an optional second adhesive layer 1116.

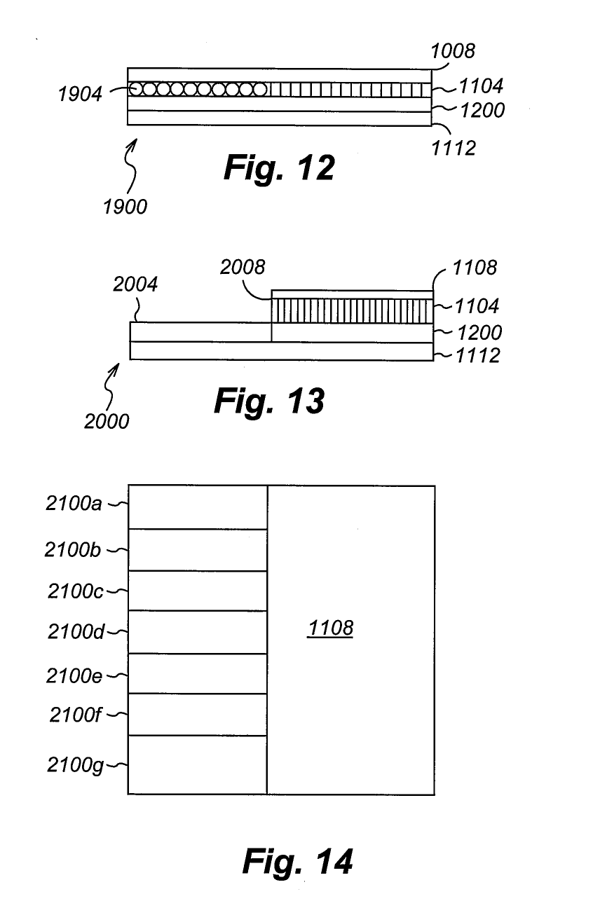

In a fifth product configuration, the product also includes a noncompatible insert 1904. With reference to FIG. 12 depicts a decorative multimedia heat transfer 1900. The heat transfer 1900 includes the porous film 1112, release adhesive 1200, flock layer 1104, nonflock media 1904, and permanent adhesive 1108. The nonflock media 1904 can be any desirable design media, including beads (shown), glitter, textiles, metal or metallized films, nonmetal films, glass particles (e.g., sequins), and the like. The permanent adhesive 1108 is applied both to the flock layer 1104 and nonflock media 1904 so that, when the adhesive is contacted with a desired target substrate and heat applied, both the flock and nonflock media are adhered permanently to the substrate. The porous film/release adhesive carrier is then removed to reveal the decorative media.

FIGS. 13-14 depict another multimedia heat transfer 2000. The transfer 2000 includes the porous film 1112, release adhesive 1200, flock layer 1104, permanent adhesive 1108, and heat transfer ink layer 2004. As can be seen in FIG. 14, the layer 2004 has a number of different colored bands 2100a-g, each band 2100a-g being a different color. The permanent and release adhesives are coterminous or coextensive with the flock layer 1104 and are absent from the area occupied by the heat transfer ink layer 2004.

The heat transfer ink layer 2004 can be any suitable heat sensitive ink-containing composition, with Plastisol being preferred. As will be appreciated in sublimation transfer ink printing, the special heat sensitive dye is deposited on a carrier paper or film. The paper or transfer is printed by a suitable technique, such as offset printing, screen printing, rotograviere printing, heliographic or flexographic printing or serigraphic printing by flat plate or rotary plate to deposit dye onto a carrier and then dried. Transferring of the ink to a desired substrate is done by placing the transfer in contact, under regulated pressure and at a predetermined temperature, generally with the aid of hot rolls or drums, with the target substrate surface, generally for a duration of about 5 seconds to about 1 minute. The hot drums can comprise, in the case of printing in formats, a hot press with horizontal plates, or in the case of continuous printing from rolls of printed paper and of synthetic material to be printed, a rotating heated cylinder associated with a belt rolling under tension. As a part of the sublimation ink printing, the target substrate is subjected to heat and pressure to thermofix the transferred sublimation dye inks. During the application of heat and pressure, the flock layer 1104 will, along with the ink, be applied to the target substrate to form a three-dimensional pattern. The adhesive 1108 is activated by the heat. After application of the flock layer 1104 to the target substrate, the film 1112 and release adhesive 1200 are removed from the flock to expose the flock layer. As will be appreciated, the flock layer 1104 can be single- or multi-colored.

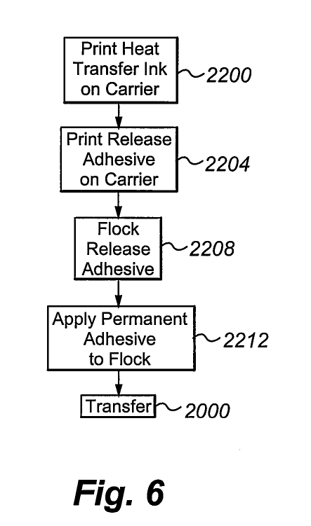

The process to manufacture the articles of FIG. 1 is shown in FIG. 5.

In step 500, the permanent adhesive is printed on the substrate in desired pattern.

In step 504, the flock fibers are deposited, preferably by electrostatic flocking techniques, on the permanent adhesive.

The flocked article 508 can then be applied to a desired substrate.

The process to manufacture the heat transfer of FIGS. 13-14 will now be described with reference to FIG. 6.

In step 2200, the heat transfer ink layer 2004 is printed onto the film 1112 in the desired areas. The areas on which the layer 2004 is applied are adhesive-free. For each ink color the ink layer is flashed after the color is applied. Thus, ink layer 2004 is printed for a first color and then flashed, for a second color and then flashed, and so forth until the various colors are applied. In the example of FIG. 14, each area containing of the first, second, third, fourth, fifth, sixth, and seventh colors 2100a-g are printed and flashed at different times.

In step 2204, the release adhesive 1200 is applied (e.g., by screen printing) to the area(s) to be flocked. Release adhesive 1200 is not applied to the area(s) occupied by the ink layer 2004.

In step 2208, the release adhesive 1200 is flocked to form a flocked surface region.

In step 2212, the permanent adhesive 1108 is applied to the flock but not to the area(s) occupied by the ink layer 2004. The transfer 2000 may be subjected to further processing, such as drying, cleaning, and adhesive curing.

When the transfer is applied to a desired target substrate, the transfer is heated to a temperature sufficient to mobilize and transfer the ink particles to the substrate and soften the adhesive 1108. Pressure is applied to the transfer 2000 to cause the adhesive to firmly adhere to the substrate. After the heat is removed, the film 1112 and release adhesive 1200 are removed to provide a three dimensional design having unflocked areas colored by the ink and flocked areas not colored by the ink. A hot split may be used. In a hot split, part of the ink remains on the film 1112 while another part of the ink is transferred to the substrate. Thus, when the film 1112 is removed, the ink layer 2004 “splits.”

In a fourth product configuration, the product is a patch. The product includes the porous film 1112 (acting as a carrier), release adhesive layer 1200, and the flock layer 1104 and excludes the permanent adhesive layer 1116.

In one direct flocked product “patch” variant, the product of FIGS. 13-14 is not configured as a transfer. Thus, the release adhesive 1200 is absent and is replaced by the permanent adhesive 1108. The permanent adhesive 1108 is absent from the upper flock surface 2008. The ink layer 2004 is typically not configured as a heat transfer layer but as a transferred layer. Thus, the layer 2004 may be applied by sublimation ink direct printing include inkjet or screen sublimation ink printing, because the layer 2004 is the final decorative layer. The designs are cut from the film 1112 and used as patches.

The third product configuration is generally produced by flocking the flock fibers on the release adhesive in the absence of heat transfer ink layer 2004. In other words, the third product configuration is formed by the steps of depositing the release adhesive 1200 in a desired pattern on the microporous film 1104, thereafter depositing flock on the release adhesive, preferably using electrostatic flocking techniques, and finally applying the permanent adhesive layer 1116 to the exposed ends of the flock.

The fourth product configuration of FIG. 3 is formed by the steps of FIG. 5, except that the insert 1304 is positioned on the permanent adhesive 1108 before flocking is performed. The insert 1304 acts as a mask and prevents flock fibers from adhering to the permanent adhesive 1108 in the area covered by the insert 1304.

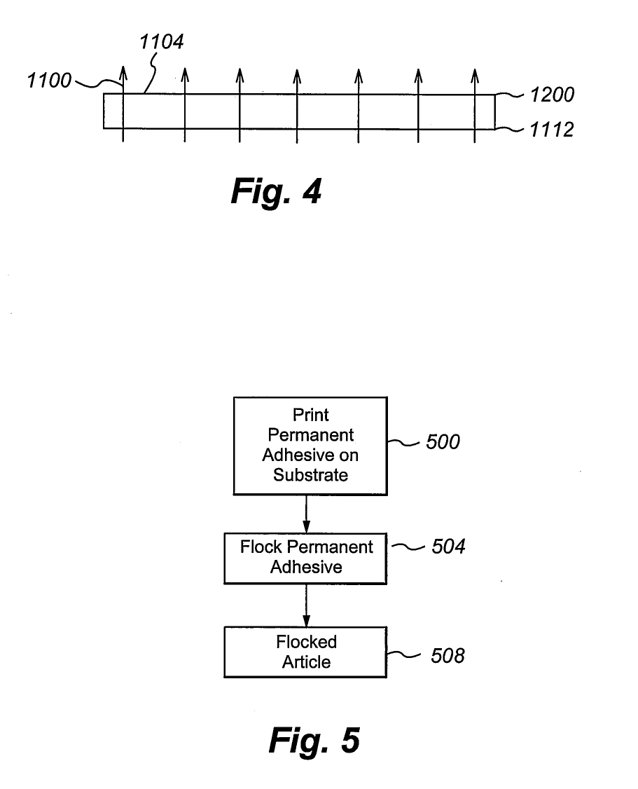

With reference to FIG. 4, a perceived benefit of the use of the preferred porous film in flocking is illustrated. As can be seen from FIG. 4, the electrostatic field 1000 passes readily through the porous film 1112 without significant decrease in the electric field strength. The field lines 1000 further maintain a substantial perpendicular orientation to the surface 1104 of the release adhesive 1200. The conductivity of the film is believed to result from its air permeability (which preferably ranges from about 1 to about 25 (MacMullin #), more preferably from about 1 to about 15, and even more preferably from about 2.5 to about 11) and water content. The film preferably has a water content ranging from about 0.5 to about 10% by weight and more preferably from about 2 to about 5% by weight.

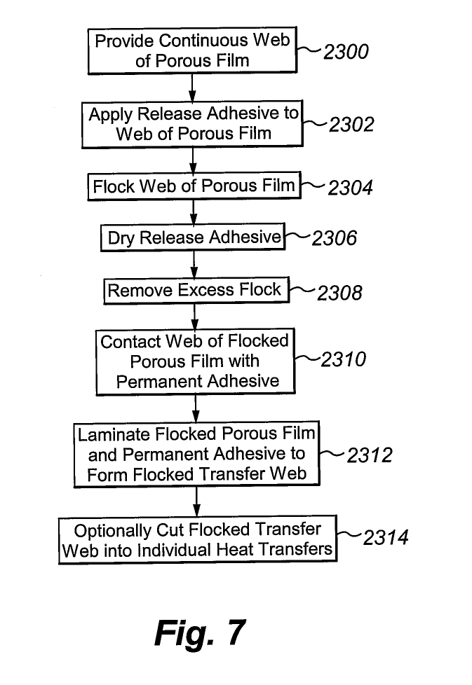

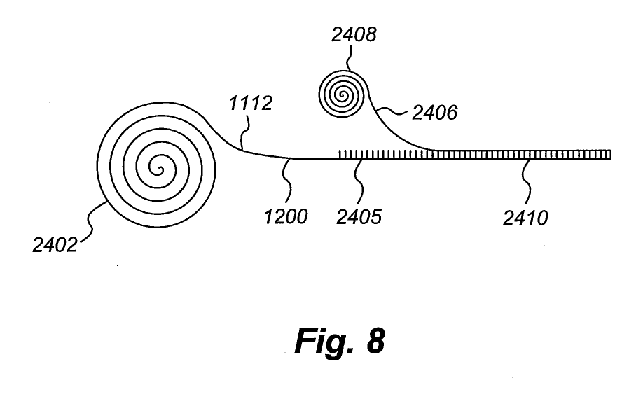

An embodiment of a process to manufacture a plurality of heat transfers of the type depicted in FIG. 2 is further illustrated in FIGS. 7-8. Thereafter, in accordance with another aspect of the present invention, the manufactured heat transfers may be bonded by high frequency energy to a continuous web of the porous film to form a web of porous film having a plurality of heat transfers bonded thereto as is discussed in detail below.

In step 2300 of the process to manufacture a plurality of individual heat transfers, a continuous web of porous film 2404 is provided. Typically, continuous web of porous film 2404 is provided on a roll 2402 and unwound.

In step 2302, the continuous web of porous film 2404 is coated with release adhesive 1200 in a desired pattern by any suitable structure or method, such as by spraying, by rollers, or by a knife.

In step 2304, continuous web of porous film 2404 is flocked, and preferably directly flocked on release adhesive 1200 by any suitable structure or method, with electrostatic flocking being preferred, to provide a continuous web of flocked porous film 2405. A first end of the flock contacts the release adhesive 1200 to hold the flock 1104 in place to porous film 1112. Flock 1104 may comprise a plurality of flock fibers of a single color or alternatively, may comprise a plurality of flock fibers of different colors. The multicolor flocking may be accomplished by a flocking wheel or any other suitable structure.

In step 2306, release adhesive 1200 is dried by passing continuous web of flocked porous film 2405 through a hot air dryer or any other suitable structure. Alternatively, release adhesive on the continuous web of flocked porous film 2405 may be dried by contact heating, for example, by conveying the roll over a heated drum. Further alternatively, the release adhesive on the continuous web may be air dried.

In step 2308, excess flock may be removed from continuous web of flocked porous film 2405. Typically, the roll is agitated, such as by vibrating or tapping, to dislodge excess flock from the top of sides of the roll and/or the excess flock is removed by vacuum.

In step 2310, the free ends of the flock on the continuous web of flocked porous film 2405 are contacted with a permanent adhesive 1116 such that the permanent adhesive physically contacts opposed second ends of the flock 1104 from the first ends. The permanent adhesive 1116 may be any suitable adhesive, such as a thermoplastic or thermoset adhesive. Preferably, the permanent adhesive is a web of thermoset adhesive conveyed from a roll 2408. Preferably also, the thermosetting adhesive is provided in the form of a pre-formed, continuous, solid, and self-supporting sheet. In one embodiment, web of thermoset adhesive 2406 is unwound from roll 2408 and continuously contacted with second ends of flock 1104 of web of flocked porous film 2405 as shown. A removable carrier film (not shown), such as any sacrificial paper liner, may also be provided on the thermosetting film. The paper liner is located on the free surface of the adhesive film. Alternatively, the permanent adhesive may be sprayed onto the free ends of the flock.

In step 2312, web of continuous flocked porous film 2405 and web of thermosetting adhesive 2406 are laminated using pressure only (with the option to apply heat and activate the adhesive later), heat only, or heat and pressure to form a flocked transfer web 2410. Thereafter, the carrier film, if provided, may be removed from flocked transfer web 2410.

Optionally, an additional adhesive, such as a thermoplastic adhesive, preferably in the form of a pre-formed, solid, and self-supporting sheet, can be contacted with and adhered to the thermosetting adhesive of flocked transfer web 2410 by lamination.

In optional step 2314, a plurality of desired heat transfer products 2412 are cut to a desired size and shape from flocked transfer web 2410. The cutting may be made by any suitable method, such as by die, and/or laser. The cut, individual heat transfers 2412 may be collected in a container below flocked transfer web 2410 while the remaining portion of the flocked transfer web 2410 continues to be conveyed.

Alternatively, the weeded portion of flocked transfer web 2410 may be rewound as product moves along the line, leaving the cut pieces on a moving belt, for example, to be collected at the end of the line.

In one embodiment, flocked transfer web 2410 can be split into two or more narrower ribbons and cut as previously described to facilitate the manufacture of bulk quantities of the individual heat transfer units.

The plurality of individually cut heat transfers are capable of being sold in bulk quantities to prospective buyers. To provide a plurality of individual heat transfers in a form that is both easily transferable and that may be used for further automated processing of the heat transfers, i.e. the subsequent adhering of the heat transfers to a substrate, the present invention further includes a method of manufacturing a continuous roll of material having a plurality of spaced apart products, such as the manufactured heat transfers, thereon.

In another embodiment, a method is provided that takes particular advantage of the ability of the porous film to be bonded to another piece of porous film (or any other compatible material) by high frequency energy without the need for adhesives or thermal heat.

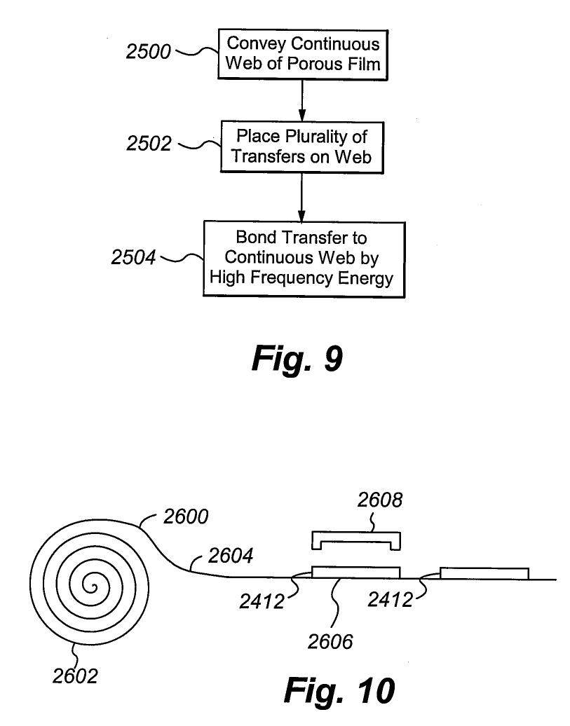

As shown in FIGS. 9-10, a method of manufacturing a continuous roll of material having a plurality of spaced-apart products bonded thereto is provided. The products may be any embodiment of decorative media having porous film as described herein, including a heat transfer, a patch, a sticker, or the like. Alternatively, the products may be any other product having an external surface comprising the porous film.

Also, as depicted in FIGS. 9-10, in step 2500, a continuous web of porous film 2600 on a roll 2602 is provided and conveyed. The continuous web of porous film 2600 enables the method to be automated. Alternatively, the porous film to which the transfers are to be bonded may be provided in the form of solid, pre-formed, and a self-supporting sheet and each of the steps of the method may be performed manually.

In step 2502, a plurality of products, such as heat transfers 2412 (with the permanent adhesive film 1116) or the direct flocked article 1100 (with or without the permanent adhesive 1116) are placed, preferably successively, on a top surface 2604 of continuous web of porous film 2600 such that a top surface 2604 of continuous web of porous film 2600 contacts the carrier sheet (i.e. porous film 1112 surface) of each heat transfer 2412. As will be appreciated, an adhesive or other intermediate material on the transfer 2412 may be bonded directly to the porous film. Heat transfers 2412 (or alternatively articles 1100) are typically placed on the web of porous film spaced apart from one another, preferably by a distance such that the film can be cut between any two heat transfers 2412 as shown. For example, heat transfers 2412 may be separated by from about 2 to 12 inches, and preferably about 6 to 10 inches, from an adjacent heat transfer in any direction.

In step 2504, heat transfers 2412 (or articles 1100) are bonded to the microporous film 2604 using high frequency energy using a high frequency energy source 2608. Typically, heat transfers 2412 are bonded to the continuous web of porous film at about the location where the heat transfers were placed in step 2502. The use of high frequency vibratory energy, preferably in combination with pressure, forms a bond and/or weld between the porous film of the heat transfer and the porous film of the continuous web. Any suitable high frequency energy source may be used to deliver high frequency energy. The high frequency energy source can be any suitable source. As the web of porous film is conveyed past the high frequency energy source 2608, the source causes the porous film surface of the heat transfer and the porous film of the continuous web to bond and/or weld together without the use of heat and adhesives. The source may contact the heat transfer on a top side thereof, contact a bottom side of the web of porous film, or both.

Preferably, the high frequency energy is applied to at least one point of contact, and preferably at least two points of contact, between the heat transfer and the web of porous film to form a weld at the points of contact. In one embodiment, high frequency energy is applied to the four corners of the heat transfer to form a weld between the heat transfer and web of porous film at the four corners of the heat transfer.

The elimination of heat and adhesives from the manufacturing process vitiates numerous safety concerns, as well as prevents the discarding of manufactured products due to scorching or extraneous adhesives. When all desired products are bonded to the web, the web can be cut and rewound to provide a web of porous film having a plurality of products bonded thereto.

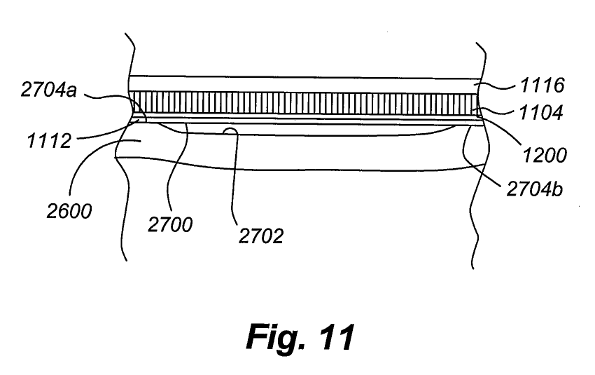

FIG. 11 depicts a cross-section of a heat transfer 2412 bonded to a web of porous film 2600. As shown, heat transfer has a layer of permanent adhesive 1116, a flock layer 1104, a layer of release adhesive 1200, and carrier (i.e. layer of porous film 1112). A bottom surface 2700 of the carrier sheet contacts a top surface 2702 of web of porous film 2600. As shown, heat transfer 2412 is bonded and/or welded to web of porous film at contact points 2704a and 2704b. Web of porous film 2600 may include a plurality of heat transfers 2412 bonded thereto or alternatively may include any other product or any plurality of other products having an exterior surface of a porous film or other material compatible with the porous film.

Alternatively, a plurality of products having an external layer of porous film may be bonded to any other compatible material. In other words, the products need not be bonded to a continuous web of porous film. Other compatible materials to which a product or article having an external porous film surface can be bonded to by high frequency energy include, but are not limited to, textiles and plastics, such as thermoplastics, PVC (polyvinyl chloride), polyester, polyethylene, polypropylene, acrylics, nylon, polycarbonate, and acetate. In one embodiment, the compatible materials include at least about 50% synthetic materials.

Another embodiment of the invention will now be discussed with reference to FIG. 16. The heat transfer 1600 includes a controlled shrinkage carrier sheet 1604, a release adhesive 1200, flock 1104, a first permanent adhesive layer 1608, and optional second permanent adhesive layer 1612. The carrier sheet 1604 is preferably a flexible carrier film that softens, shrinks, or otherwise absorbs freely shrinkage of the adhesive layer(s), including during thermal treatment (as shown by the equal length of the inwardly facing arrows in the adhesive layer 1608 and sheet 1604). The various adhesive layers 1200, 1608, and 1612 can be any of the adhesives discussed herein.

Substantial absorption of the shrinking tension can be done in several ways.

In a first way, the carrier sheet is not rigid or semi-rigid but flexible and/or soft. The flexibility and/or softness allows the carrier sheet to absorb the tension exerted on it by shrinkage of the adhesive layer(s). Flexibility can be measured in many ways. For microporous films, a common test used to determine the flexibility is provided in ASTM D1388-64. A strip of the film is placed on a support so that its end projects from the horizontal surface of the support. The fabric is held in place by a weight. The length of overhang is measured when the film is depressed under its own weight to the point where the line joining the strip of the film to the edge of the support makes an angle of 51.5 degrees from horizontal. One half of this length is the bending radius of the sample. Softness can be measured by shore A or D durometer hardness, with a lower value indicating a higher degree of softness. For example, a shore A durometer hardness of typically 75 or less and even more typically of 50 or less would be considered soft by one of ordinary skill in the art. Regardless of the test or measure, the film preferably has a relatively high degree of flexibility and/or softness and a relatively low degree of rigidity. Preferably, the flexible carrier film has a thickness of less than 14 mil, even more preferably no more than about 12 mil, and even more preferably no more than about 10 mil.

In a second way, the carrier film 1604 is a thermoplastic material that softens at the processing temperatures to which the heat transfer 1600 is subjected. In other words, the carrier film is selected to have a softening point less than the maximum and even more preferably the minimum elevated temperature of the thermal treatment steps. The softened carrier film will absorb more readily shrinkage in the adhesive layer(s) due to drying and curing.

In a third way, the carrier film 1604, though not shrinkable due to thermal heating alone, has a porous or cellular (e.g., foam) structure that enables it to shrink in response to shrinkage of the adhesive layer(s).

In a fourth way, the carrier film itself shrinks at substantially the same rate as the adhesive layer(s). During heat transfer, the energy that is stored in the intermolecular bonds between atoms changes. When the stored energy increases, so does the length of the molecular bond. As a result, solids typically expand in response to heating and contract on cooling; this response to temperature change is expressed as its coefficient of thermal expansion. The coefficient of thermal expansion is used in two ways, namely (a) as a volumetric thermal expansion coefficient and (b) as a linear thermal expansion coefficient. These characteristics are closely related. The volumetric thermal expansion coefficient can be measured for all substances of condensed matter (liquids and solid state). The linear thermal expansion can be measured only in the solid state. In this approach, the linear and volumetric thermal expansion coefficients of the carrier sheet 1604 are comparable to the corresponding thermal expansion coefficient of the permanent adhesive layer(s) 1608, 1612 under the processing temperatures to which the heat transfer is subjected. Preferably, the thermal expansion coefficients of the carrier sheet 1604 are within about 25% of the corresponding thermal expansion coefficient of the most thermally expansive permanent adhesive layer. More preferably, the thermal expansion coefficients of the carrier sheet 1604 are within about 10% of the corresponding thermal expansion coefficient of the most expansive permanent adhesive layer. Even more preferably, the thermal expansion coefficients of the carrier sheet 1604 are within about 5% of the corresponding thermal expansion coefficient of the most expansive permanent adhesive layer. This result can be realized by selecting a permanent adhesive layer and carrier sheet having similar thermal properties, either isotropic or anisotropic. In one configuration, the permanent adhesive layer and carrier sheet have a common polymer as the primary component. For example, a polyurethane permanent adhesive can be coupled with a polyurethane carrier sheet 1604.

Accordingly, the carrier film is not limited to microporous films but can be any polymeric material having the properties described above.

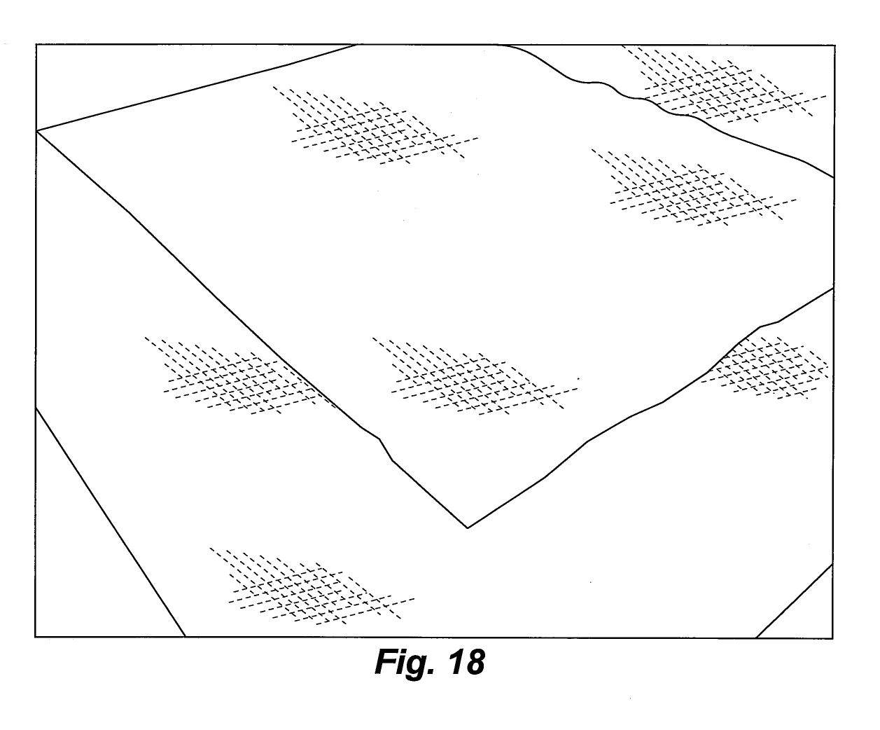

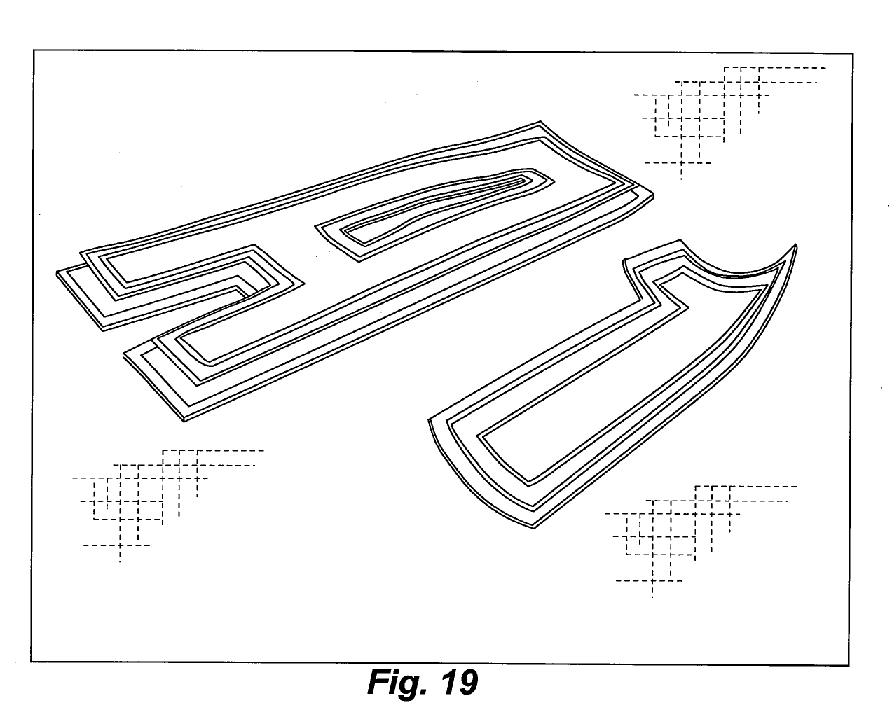

FIG. 18 depicts a (porous) carrier sheet 1604 viewed from the rear in the heat transfer 1600. The carrier sheet 1604 has curled up, being pulled by the shrinking permanent adhesive layer(s) on the reverse (unseen) side. This allows the permanent adhesive layer(s) to shrink instead of being on the carrier sheet 1604 under tension.

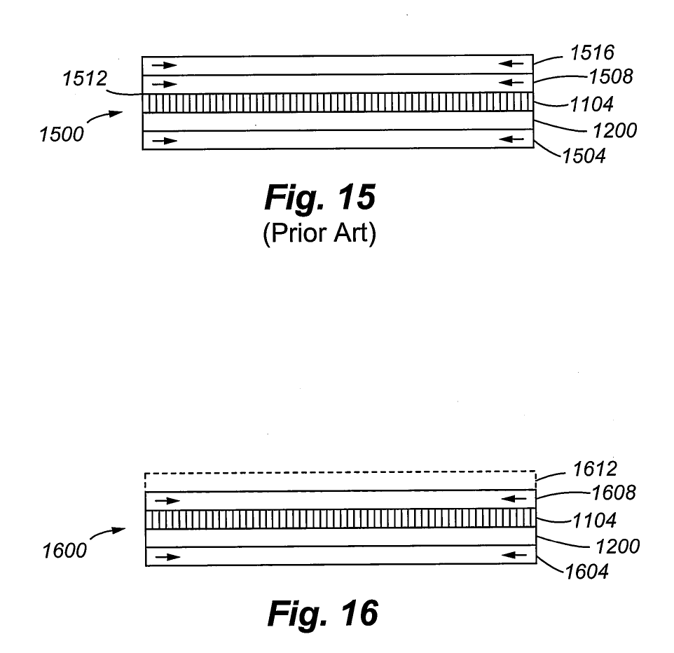

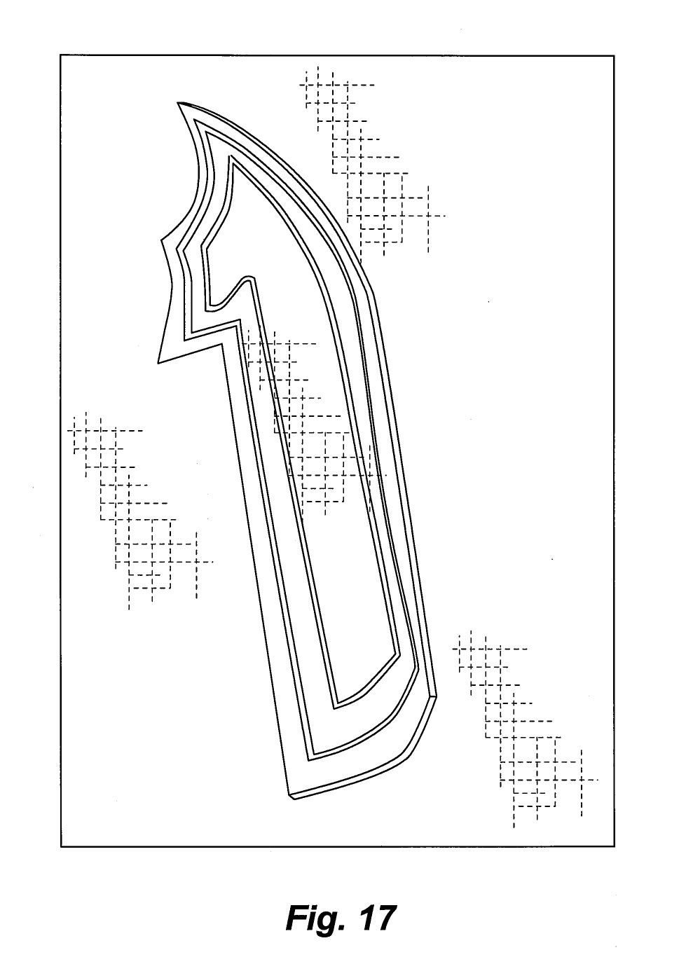

FIG. 19 is a side-by-side comparison of the heat transfers of FIGS. 15 and 16 after each is removed from the carrier sheet 1504, 1604. The heat transfer 1500 of FIG. 15 (which is the number “1”) has curled significantly. The heat transfer 1600 of FIG. 16 (which is the letter “A”) is flat lying.

The heat transfer 1600 can be manufactured by any suitable process, with the process of FIG. 6 being preferred. In step 2212, the permanent adhesive can be applied in liquid or solid form. In one configuration, a flock binder adhesive, such as a latex adhesive, is applied as layer 1608, and, while the adhesive is wet, a powdered hot-melt adhesive is sprinkled on the upper surface of the binder adhesive to form layer 1612. The transfer is then dried at room temperature or heated to a temperature typically of at least about 90 degrees Fahrenheit and even more typically ranging from about 100 to about 130 degrees Fahrenheit to dry the binder adhesive. The dried heat transfer is baked and cured at a temperature preferably of at least about 325 degrees Fahrenheit and even more preferably from about 350 to about 400 degrees Fahrenheit for a time of no more than about 5 minutes. The heat transfer is later applied to a desired textile by heating the hot melt adhesive 1612 above its softening and/or melting temperatures. During application, the transfer is heated typically to a temperature typically of at least about 300 degrees Fahrenheit and even more typically ranging from about 325 to about 375 degrees Fahrenheit. The shrinkage and/or deformation under either temperature is absorbed substantially by the carrier sheet 1604.

A number of variations and modifications of the invention can be used. It would be possible to provide for some features of the invention without providing others.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) applying a release adhesive to a shrinkage control carrier film; and
(b) electrostatically flocking the release adhesive to form of a flock layer;
(c) applying a permanent adhesive to a free surface of the flock, the flock being positioned between the permanent adhesive and release adhesive, to form a transfer; and
(d) drying the permanent adhesive of the transfer, causing the permanent adhesive to shrink and/or deform in at least one dimension, wherein the carrier film has at least one of the following features:
(D1) a thermal expansion coefficient that ranges from about 75% to about 125% of a thermal expansion coefficient of the permanent adhesive;
(D2) a softening temperature less than the drying temperature;
(D3) a primary component that is the same as a primary component of the permanent adhesive;
(D4) a porous and/or cellular structure; and
(D5) a high degree of flexibility.
whereby at least most of the shrinkage and/or deformation is absorbed by the carrier film.

2. The method of claim 1, wherein the carrier film has feature (D1).

3. The method of claim 2, wherein the thermal expansion coefficient of the carrier sheet ranges from about 90% to about 110% of a thermal expansion coefficient of the permanent adhesive.

4. The method of claim 1, wherein the carrier film has feature (D2).

5. The method of claim 1, wherein the carrier film has feature (D3).

6. The method of claim 1, wherein the carrier film has feature (D4).

7. The method of claim 6, wherein the porous film is a microporous film, wherein the microporous film comprises an inorganic filler, wherein the porous film comprises a matrix of substantially water insoluble thermoplastic organic polymer and filler particles and is gas permeable but water impermeable.

8. The method of claim 6, wherein the porous film comprises a substantially nonporous coating, the coating comprising a film forming polymer.

9. The method of claim 6, wherein the porous film is a microporous film, wherein the microporous film comprises a particulate filler, wherein the filler comprises from about 40 to about 90 weight percent of the porous film, wherein the filler particles have a maximum dimension of less than about 5 micrometers, wherein the pores of the porous film are from about 35 to about 95 percent by volume of the porous film, wherein the filler is a metal oxide, wherein the porous film comprises a substantially nonporous coating, wherein the coating comprises a binder, wherein the binder is a film-forming polymer, and wherein the binder has a molecular weight ranging from about 100,000 to about 300,000.

10. The method of claim 6, wherein the porous film has a thickness of less than 14 mils.

11. The method of claim 1, wherein the carrier film has feature (D5).

12. The method of claim 1, wherein the carrier film has a thickness of no more than about 12 mils.

13. A flocked article, comprising:
(a) a permanent adhesive layer;
(b) a plurality of flock fibers;
(c) a release adhesive, the flock fibers being positioned between the permanent adhesive layer and release adhesive; and
(d) a control shrinkage carrier film adhered to the release adhesive, the release adhesive being located between the control shrinkage carrier film and the flock fibers, wherein the control shrinkage carrier film has at least one of the following features:
(D1) a thermal expansion coefficient ranging from about 75% to about 125% of a thermal expansion coefficient of the permanent adhesive;
(D2) a softening temperature less than the elevated temperature;
(D3) a primary component that is the same as a primary component of the permanent adhesive;
(D4) a porous and/or cellular structure; and
(D5) a high degree of flexibility.

14. The flocked article of claim 13, wherein the carrier film has feature (D1).

15. The flocked article of claim 14, wherein the thermal expansion coefficient of the carrier sheet ranges from about 90% to about 110% of a thermal expansion coefficient of the permanent adhesive.

16. The flocked article of claim 13, wherein the carrier film has feature (D2).

17. The flocked article of claim 13, wherein the carrier film has feature (D3).

18. The flocked article of claim 13, wherein the carrier film has feature (D4).

19. The flocked article of claim 18, wherein the porous film is a microporous film, wherein the microporous film comprises an inorganic filler, wherein the porous film comprises a matrix of substantially water insoluble thermoplastic organic polymer and filler particles and is gas permeable but water impermeable.

20. The flocked article of claim 18, wherein the porous film comprises a substantially nonporous coating, the coating comprising a film forming polymer.

21. The flocked article of claim 18, wherein the porous film is a microporous film, wherein the microporous film comprises a particulate filler, wherein the filler comprises from about 40 to about 90 weight percent of the porous film, wherein the filler particles have a maximum dimension of less than about 5 micrometers, wherein the pores of the porous film are from about 35 to about 95 percent by volume of the porous film, wherein the filler is a metal oxide, wherein the porous film comprises a substantially nonporous coating, wherein the coating comprises a binder, wherein the binder is a film-forming polymer, and wherein the binder has a molecular weight ranging from about 100,000 to about 300,000.

22. The flocked article of claim 13, wherein the carrier film has feature (D5).

23. A method, comprising:
(a) applying a release adhesive to a porous and/or cellular carrier film; and
(b) electrostatically flocking the release adhesive to locate a plurality of flock fibers in the release adhesive, the fibers being transverse to an adjacent surface of the carrier film;
(c) applying a permanent adhesive to a free surface of the flock, the flock being positioned between the permanent adhesive and release adhesive, to form a transfer;
(d) heating the transfer to an elevated temperature to cause the permanent adhesive to shrink in at least one dimension;
(e) absorbing, by the carrier film, at least most of the shrinkage of the permanent adhesive.

24. The method of claim 23, wherein the porous film is a microporous film, wherein the microporous film comprises an inorganic filler, wherein the porous film comprises a matrix of substantially water insoluble thermoplastic organic polymer, filler particles and is gas permeable but water impermeable, wherein the filler comprises from about 40 to about 90 weight percent of the porous film, wherein the filler particles have a maximum dimension of less than about 5 micrometers, wherein the pores of the porous film are from about 35 to about 95 percent by volume of the porous film, wherein the filler is a metal oxide, and wherein the porous film comprises a substantially nonporous coating, the coating comprising a film forming polymer, wherein the coating comprises a binder, wherein the binder is a film-forming polymer, and wherein the binder has a molecular weight ranging from about 100,000 to about 300,000.

25. The method of claim 17, wherein the porous film has a thickness of less than about 14 mil.
